(19) United States
(12) Patent Application Publication
(10) Pub. No.: US 2006/0069209 A1
(43) Pub. Date: Mar. 30, 2006

(54) Heat stable functionalized polyolefin emulsions

(76) Inventor: Daniel W. Klosiewicz, Kingsport, TN (US)

Correspondence Address: Polly C. Owen, Eastman Chemical Company, P.O. Box 511, Kingsport, TN, 37662-5075, US

(21) Appl. No.: 11/031,727

(22) Filed: Jan. 7, 2005

Related U.S. Application Data
(60) Provisional application No. 60/614,097, filed on Sep. 29, 2004.
(60) Provisional application No. 60/614,087, filed on Sep. 29, 2004.
(60) Provisional application No. 60/614,156, filed on Sep. 29, 2004.
(60) Provisional application No. 60/614,138, filed on Sep. 29, 2004.

(51) Int. Cl. C08F 297/02

(52) U.S. Cl. 525/242

(57) ABSTRACT

Heat stable functionalized polyolefin emulsions are provided comprising at least one additive wherein the additive comprises at least one phosphorous-based oxo acid moiety. The additive can also comprise at least one phosphorous-based oxo acid moiety and at least one sulfur-based oxo acid moiety. Processes for producing the heat stable functionalized polyolefin emulsions and articles comprising the heat stable functionalized polyolefin emulsions are also provided.

### CROSS REFERENCES TO RELATED APPLICATIONS

This application claims the benefit of United States Provisional Application entitled “Heat Stable Functionalized Polyolefin Emulsions” having Ser. No. 60/614,097 filed on Sep. 29, 2004, United States Provisional Application entitled “Functionalized Polyolefin Emulsions” having Ser. No. 60/614,087 filed on Sep. 29, 2004, United States Provisional Application entitled “Processes for Producing Functionalized Polyolefin Emulsions” having Ser. No. 60/614,156 filed on Sep. 29, 2004, United States Provisional Application entitled “Alicyclic Carboxylic Acid-Containing Functionalized Polyolefins” having Ser. No. 60/614,138 filed Sep. 29, 2004; all of which are hereby incorporated by reference in their entirety to the extent they do not contradict the statements herein.

### FIELD OF THE INVENTION

The present invention relates to heat stable, functionalized polyolefin emulsions comprising at least one additive wherein the additive comprises at least one phosphorous-based oxo acid moiety. More specifically, the invention relates to heat stable, functionalized polyolefin emulsions comprising at least one additive wherein the additive comprises at least one phosphorous-based oxo acid moiety and at least one sulfur-based oxo acid moiety.

The present invention also relates to processes for producing heat stable, functionalized polyolefin emulsions and to articles comprising the heat stable, functionalized polyolefin emulsions.

### BACKGROUND OF THE INVENTION

Aqueous emulsions of various types of functionalized polyolefins have been used commercially since the late 1950s. Various methods for emulsifying low molecular weight polyolefins have been described by Force, in U.S. Pat. No. 3,912,673, von Bramer et al., “Polish Emulsion by Pressure Method,” Soap and Chemical Specialties, December, 1966, and Nalley et al., U.S. Pat. No. 3,655,353.

Emulsions of functionalized polyolefins have a variety of uses. For examples, emulsions of functionalized polyolefins are used in floor and car polishes, temporary metal coatings, corrugated and paper coatings, textile softeners and lubricants, fiberglass sizing, and paper calendaring lubricants and citrus fruit coatings. However, when functionalized polyolefin emulsions are dried, the dried emulsions can often exhibit dark colors, for example, having a Gardner color greater than G8. This can be detrimental to various applications for the functionalized polyolefin emulsions.

For example, emulsions of high molecular weight maleated polypropylene can be used to size glass fibers used in polypropylene composite materials where the maleated polypropylene serves as a binder to hold the fibers together and also serves to improve the subsequent coupling of the glass fiber to the polypropylene matrix. Emulsions of high molecular weight maleated polypropylene, having a weight average molecular weight ranging from about 30,000 to about 90,000, can exhibit superior mechanical properties as compared to corresponding fiberglass sized with an emulsion of lower molecular weight maleated polypropylene. However, one major shortcoming of this type size formulation is poor color stability after heating. The dried, high molecular weight, maleated polypropylene emulsion after being conditioned for only 30 minutes or less in air at 180° C. changed from a light color film to a very dark colored material having a Gardner color between about 8 and about 12. Therefore, due to this dark color, the high molecular weight maleated polypropylene emulsion is typically used in black components.

Therefore, there is a need in the industry for functionalized polyolefin emulsions having low color.

### BRIEF SUMMARY OF THE INVENTION

It is an object of this invention to provide heat stable, functionalized polyolefin emulsions.

It is also an object of this invention to provide processes to produce heat stable, functionalized polyolefin emulsions.

It is a further object of this invention to provide sizing compositions comprising the heat stable, functionalized polyolefin emulsions.

It is yet another object of this invention to provide articles comprising the heat stable, functionalized polyolefin emulsions.

In accordance with an embodiment of this invention, a heat stable functionalized polyolefin emulsion is provided comprising at least one additive wherein the additive comprises at least one phosphorous-based oxo acid moiety.

In accordance with another embodiment of this invention, a composition is provided comprising a heat stable functionalized polyolefin emulsion wherein the functionalized polyolefin emulsion when heat aged has a Gardner Color of less than or equal to about 6.

In accordance with another embodiment of this invention, a heat stable functionalized polyolefin emulsion is provided comprising at least one functionalized polyolefin, at least one non-ionic surfactant, at least one neutralizing base, at least one carboxylic acid co-surfactant, at least one additive, and water wherein said additive is at least one phosphorous-based oxo acid moiety. In another embodiment, the additive comprises at least one phosphorus-based oxo-acid moiety and at least one sulfur-based oxo acid moiety.

In accordance with another embodiment of this invention, a process is provided to produce the heat stable functionalized polyolefin emulsion. The process comprises contacting at least one functionalized polyolefin, at least one non-ionic surfactant, at least one neutralizing base, at least one carboxylic acid co-surfactant, at least one additive, and water; wherein the additive is at least one phosphorous-based oxo acid moiety. In another embodiment, the additive comprises at least one phosphorus-based oxo-acid moiety and at least one sulfur-based oxo acid moiety.

Embodiments of this invention provide functionalized polyolefin emulsions having an acceptable color after heat aging (heat age color) as shown by a Gardner color less than or equal to 6.

### DETAILED DESCRIPTION

The terms as used in this disclosure are defined as follows. The term “heat stable or heat stability” means the heat aged color of the functionalized polyolefin emulsion is less than or equal to 6 as determined by the method described in the examples section of this disclosure.

The term “heat aged color” or “color after heat aging” means the Gardner color determined after heat aging according to the heat aged color procedure outlined in the examples section of this disclosure.

The term “acceptable color” or “acceptable heat aged color” is defined as a functionalized polyolefin emulsion having a Gardner color of less than or equal to 6 determined according to the heat aged color procedure in the examples section of this disclosure.

The term “acceptable emulsion” is defined as an emulsion having a transmittance of greater than 5%. Transmittance is determined by the procedure in the examples section of this disclosure.

The term “stable emulsion” is defined as an emulsion where the ingredients do not separate and the particles do no agglomerate.

In one embodiment of this invention, a functionalized polyolefin emulsion is provided comprising at least one additive wherein the additive comprises at least one phosphorous-based oxo acid moiety.

The functionalized polyolefin emulsion can be any known in the art. Generally, the functionalized polyolefin emulsion comprises at least one functionalized polyolefin, at least one non-ionic surfactant, at least one neutralizing base, at least one carboxylic acid co-surfactant, and water.

The functionalized polyolefin can be any functionalized polyolefin that is known in the art. As used herein, functionalization of polyolefins refers to the addition of acid groups to the polyolefin by a functionalizing agent. Functionalization can be achieved by any method known in the art. For example, thermal oxidation and grafting are processes that can be utilized.

In one embodiment of the invention, the polyolefins to be functionalized comprise at least one olefin monomer having from 2 to about 8 carbon atoms, preferably from 2 to about 6 carbon atoms. Examples of such polyolefins include, but are not limited to, polyethylene, polypropylene, polybutene, and polyhexene. The polyolefins to be functionalized can be homopolymers, copolymers, or terpolymers. Preferred polyolefins are homopolymers and copolymers of low, medium, and high density polyethylene and homopolymers and copolymers of crystalline and amorphous polypropylenes. More preferred are crystalline homopolymers or copolymers of propylene. Other suitable polyolefins, include, but are not limited to, thermoplastic elastomers such as ethylene-propylene rubber (EPR) and ethylene-propylene-diene rubber (EPDM).

The functionalizing agent can be any that are known in the art. In one embodiment, the functionalizing agent can be any unsaturated monomer containing one or more carboxylic acid or acid anhydride groups that can functionalize the polyolefin. Examples of suitable functionalizing agents are carboxylic acids, such as, acrylic acid and methacrylic acid, and acid anhydrides, such as, maleic anhydride. Further functionalizing agents include, but are not limited to, unsaturated monocarboxylic acids, polycarboxylic acids, and cyclic acid anhydrides. Specifically included herein are acids, such as, maleic acid, flumaric acid, himic acid, itaconic acid, citraconic acid, mesaconic acid, acrylic acid, methacrylic acid, crotonic acid, isocrotonic acid, and acid anhydrides, such as, maleic anhydride and himic anhydride. In one embodiment of this invention, the use of maleic anhydride is preferred for the functionalization of polypropylene. Mixtures of functionalizing agents may be utilized in the present invention.

In one embodiment of this invention, the functionalized polyolefins have a grafting level of about 0.5% by weight to about 2.5% by weight grafted functionalizing agent based on the weight of the functionalized polyolefin, preferably, from about 1.2% by weight to about 2% by weight grafted functionalizing agent based on the weight of the functionalized polyolefin. In another embodiment of the invention, when the functionalized polyolefin is maleated polypropylene, the grafting level can range from about 0.5% by weight to about 2.5% by weight, preferably from about 1% by weight to about 2.5% by weight, and most preferably from 1.3% by weight to 2.0% by weight of grafted maleic anhydride based on the weight of the maleated polypropylene. The graft level (% by weight grafted functionalizing agent based on the weight of the functionalized polyolefin) is calculated from the acid number. Lower graft levels result in maleated polypropylene having ligher color. In addition, lower graft levels can also minimize polymer degradation.

In one embodiment of the invention, the graft distribution of the functionalized polyolefin should be with good uniformity in order to produce high quality functionalized polyolefin emulsions. For example, with maleated polypropylene, where the maleic anhydride reacts to form both highly grafted oligomeric species and a substantial amount of polyolefin remains unmodified, the functionalized polyolefin can be difficult or impossible to emulsify even though the graft level, calculated by the acid number, may indicate maleic anhydride content in the desired range.

Related to grafting level is the acid number of the functionalized polyolefin, which is the number of milligrams of potassium hydroxide that is required to neutralize the carboxylic acid functionality present in 1 gram of the functionalized polyolefin where the test is designed to consume 1 millimole of potassium hydroxide for every millimole of functional group present. The grafting level is calculated from the acid number of the functionalized polyolefin. The acid number of a functionalized polyolefin is the number of milligrams of potassium hydroxide that is required to neutralize the functional group present in 1 gram of the functionalized polyolefin where the test is designed to consume 1 millimole of potassium hydroxide for every millimole of functional group present. For example, when titrating grafted maleic anhydride groups, methanolic potassium hydroxide is used so that each maleic functionality consumes only one potassium hydroxide even though maleic anhydride can form a diacid. The acid number is obtained by titrating weighed samples of functionalized polyolefin dissolved in refluxing xylene with methanolic potassium hydroxide using phenolphthalein as an indicator. The acid number is distinguished from the saponification number which is measured in an aqueous system while the acid number is measured in a water-free system. By using an aqueous system for the titration of the functionalized polyolefin, the functionalizing agent is hydrolyzed, and twice the amount of potassium hydroxide is needed for neutralization. Therefore, the saponification number is twice as high as the acid number.

In one embodiment of this invention, the acid number of the functionalized polyolefin can range from about 4 to about 14, preferably from 6 to 12. Acid numbers for maleated polypropylene can range from about 4 to about 14, preferably from 7 to 12.

Polymer strength is positively correlated with molecular weight; therefore, higher molecular weight functionalized polyolefins generally have more desirable physical properties than lower molecular weight functionalized polyolefins. In one embodiment of this invention, the weight average molecular weight of the functionalized polyolefin can range from about 30,000 to about 90,000, preferably ranging from 40,000 to 70,000 for most of the uses described previously. The weight average molecular weight for maleated polypropylene can range from about 30,000 to about 90,000, preferably from 40,000 to 70,000.

The melt viscosity at 190° C. of the functionalized polyolefin is that which is sufficient to obtain properties useful in the application for the functionalized polyolefin emulsion. The melt viscosity at 190° C. was measured using a Thermosel viscometer manufactured by the Brookfield Instrument Company. In one embodiment of this invention, the melt viscosity at 190° C. is greater than 10,000 centipoise, preferably ranging from about 20,000 centipoise to about 150,000 centipoise, and most preferably ranging from 40,000 centipoise to 100,000 centipoise. The melt viscosity for maleated polypropylene can range from about 20,000 to about 150,000, preferably from 40,000 to 100,000.

The peak melt point measured by differential scanning calorimetry of the functionalized polyolefin is that which is sufficient to obtain properties useful in the particular application for the functionalized polyolefin emulsion. In one embodiment of this invention, the peak melt point of the functionalized polyolefin is greater than 130° C., preferably greater than 150° C. The peak melt point for maleated polypropylene can range from about 130° C. to about 165° C., preferably from 155° C. to 165° C.

The amount of the functionalized polyolefin is that which is sufficient to obtain properties useful in the particular application of the functionalized polyolefin emulsion. In one embodiment of this invention, the amount of the functionalized polyolefin can range from about 10% by weight to about 35% by weight based on the weight of the functionalized polyolefin emulsion, preferably from 20% by weight to 30% by weight. For maleated polypropylene emulsions, the amount of maleated polypropylene can range from about 10% by weight to about 35% by weight based on the weight of the maleated polypropylene emulsion, preferably from 20% by weight to 30% by weight.

The functionalized polyolefin can be produced by any process known in the art. The process can be either batch or continuous. In a batch process, generally, all of the reactants and products are maintained in the reaction vessel for the entire batch preparation time. In a continuous process, the ingredients are feed at a continuous rate to the process.

Typical processes for producing functionalized polyolefins include, but are not limited to, solid phase, solvent, or extrusion processes. In a solid phase process, the polyolefin is heated to a temperature below the melting point of the polyolefin. Then, the functionalizing agent and initiator are added to the heated polyolefin to produce the functionalized polyolefin. U.S. Pat. Nos. 4,595,726 and 5,140,074, herein incorporated by reference in their entirety to the extent they do not contradict the statements herein, utilize the solid phase process.

In solvent processes, solvent is added to swell the polyolefin to allow functionalization by the functionalizing agent. U.S. Pat. Nos. 4,675,210 and 4,599,385, herein incorporated by reference in their entirety to the extent they do not contradict the statements herein, utilize the solvent process.

In extrusion processes, the polyolefin, functionalizing agent, and at least one initiator are fed to an extrusion zone where grafting takes place. The extrusion zone comprises at least one extruder. U.S. Pat. Nos. 5,955,547, 6,046,279, and 6,218,476, herein incorporated by reference in their entirety to the extent they do not contradict the statements herein, describe extrusion processes for producing functionalized polyolefins, particularly maleated polypropylenes.

The functionalized polyolefins, particularly maleated polypropylene, can also be characterized into two product types as a function of whether or not solvent is utilized, either as a solvent during reaction or in workup of the functionalized polyolefins. In U.S. Pat. Nos. 3,414,551; 4,506,056; and 5,001,197, herein incorporated by reference in their entirety to the extent they do not contradict the statements herein, the workup of the functionalized polyolefin involves dissolving the functionalized polyolefin in a solvent followed by precipitation, or washing with solvent. This treatment removes soluble components and thus varies both the apparent molecular weight and acid number.

In one particular embodiment of this invention, the maleated polypropylene is prepared by an extrusion process utilizing a polypropylene having a peak melt point greater than 135° C. The polypropylene is combined in the melt with maleic anhydride that is added at a level between about 1.0 parts by weight to about 2.5 parts by weight per 100 parts by weight of polypropylene, and the peroxide initiator is added at a level up to about 2.0% by weight based on weight of the polypropylene. The polypropylene, maleic anhydride, and peroxide initiator are mixed in the extruder at a temperature in the range of about 160° C. to about 250° C. The maleated polypropylene after stripping to remove unreacted maleic anhydride generally exhibits greater than about 1.2% reacted (grafted) maleic anhydride measured by acid titration using methanolic KOH.

Non-ionic surfactants can be any that are known in the art capable of emulsifying the functionalized polyolefin. Non-ionic surfactants include, but are not limited to, compounds based on ethylene oxide and alkyl phenols, ethoxylated derivatives of C₈ to C₂₀ linear alcohols, ethoxylated C₉ to C₁₈ synthetic branched alcohols, ethoxylated alkyl phenol derivatives, mono esters of aliphatic carboxylic acids and polyethylene oxide oligomers of varying molecular weight, and similar mono- or di-esters of polyhydroxy material, such as, sorbitol-monolaurate. Of this group, non-ionic surfactants based on the reaction of alcohols or alkyl phenols with ethylene oxide, propylene oxide, or mixtures of the two are most preferred because of the stability of the ether linkage joining the hydrophilic and hydrophobic ends.

For functionalized polyolefins having a graft level less than 2.5% functionalizing agent based on the weight of the functionalized polyolefin, the non-ionic surfactant used should have the proper HLB characteristics based on the graft level of the functionalized polyolefin to produce a stable functionalized polyolefin emulsion. A stable functionalized polyolefin emulsion is one where the ingredients do not separate or the particles do not agglomerate. Preferably, the functionalized polyolefin emulsion has a transmittance greater than 5%. The method of measuring transmittance is described subsequently in the examples section of this disclosure.

For non-ionic surfactants, which are amphiphallic and comprised of both a hydrophobic end and a hydrophillic ethylene oxide segment, HLB is an indicator of the relative amounts of hydrophillic and hydrophobic segments in the surfactant. The percentage of hydrophillic groups in the surfactant is roughly equal to (HLB/20)×100. For example, a non-ionic surfactant with a HLB equal to 10 has about 50% of its molecule consisting of polar ethylene oxide groups while a non-ionic surfactant with a HLB equal to 15 has about 75% of its structure as polar ethylene oxide units.

To emulsify functionalized polyolefins with graft levels greater than 2.5% by weight functionalizing agent based on the weight of the functionalized polyolefin, such as Epolene E-43 or G-3015 maleated polypropylene produced by Eastman Chemical Company, a non-ionic surfactant with a HLB value of about 11 to about 15 is typically used. Functionalized polyolefins having lower grafting level and higher molecular weight are more difficult to emulsify. In order to emulsify these functionalized polyolefins having a graft level less than or equal to about 2.5% by weight functionalizing agent based on the weight of the functionalized polyolefin, it would be expected that ionic surfactants having higher HLB values should be utilized, but this is surprisingly not the case as discussed subsequently.

For example, Epolene G-3003 maleated polypropylene produced by Eastman Chemical Company with about 1.4 weight % grafted maleic anhydride based on the weight of the maleated polypropylene emulsifies well using non-ionic surfactants or mixtures of non-ionic surfactants having an average HLB value of between about 8 and about 9. As the grafting level of the functionalized polyolefin increases, the optimum HLB of the non-ionic surfactant increases with the increasing graft level in order to produce the optimum functionalized polyolefin emulsion as indicated by good transmittance and filterability. Good transmittance and filterability are defined in the Examples Section of this disclosure. For instance, the optimum HLB for the non-ionic surfactant to emulsify Epolene G-3015 maleated polypropylene produced by Eastman Chemical Company with about 3% grafted maleic anhydride ranges from about 11 to about 14. However, these same non-ionic surfactants fail to produce a stable functionalized polyolefin emulsion when used with Epolene G-3003 maleated polypropylene having a 1.4% grafting level.

In one embodiment of this invention, when emulsifying functionalized polyolefins have a grafting level between about 0.5% by weight to about 2.5% by weight based on the weight of the functionalized polyolefin, the non-ionic surfactant can be any non-ionic surfactant or mixture of non-ionic surfactants known in the art having a HLB ranging from about 4 to about 10. As mentioned previously, optimal functionalized polyolefin emulsions are obtained by choosing the appropriate HLB range based on the grafting level of the functionalized polyolefin. Preferably, the HLB value of the non-ionic surfactant can range from about 6 to about 10, and most preferably from 7 to 10.

Preferably, non-ionic surfactants or non-ionic surfactant mixtures with a HLB value in the range of about 8 to about 9 tend to be most effective when emulsifying Epolene G-3003 maleated polypropylene. Most preferably, the non-ionic surfactant for producing emulsions of Epolene G-3003 maleated polypropylene (1.4 wt % maleic anhydride based on the weight of the maleated polypropylene) produced by Eastman Chemical Company is a roughly 70/30 mixture of Brij 30 and Brij 72 obtained from Uniquema Chemical Company where the calculated HLB of the blend is about 8.5. It has been found that non-ionic surfactants with even lower HLB values tend to require higher levels of carboxylic acid co-surfactant to produce stable emulsions.

Combinations of non-ionic surfactants can also be used. For example, combinations of non-ionic surfactants having high and low HLB values can be utilized to arrive at the HLB necessary to emulsify a particular functionalized polyolefin.

The amount of non-ionic surfactant present in the functionalized polyolefin emulsion is that which is sufficient to obtain a stable emulsion. A stable functionalized polyolefin emulsion was previously defined in t his disclosure. Preferably, the amount of the non-ionic surfactant present in the functionalized polyolefin emulsion is that which is sufficient to obtain an acceptable emulsion as indicated by a transmittance of at least 5%. In one embodiment, the amount of non-surfactant can range from about 6 parts by weight per 100 parts by weight of functionalized polyolefin to about 25 parts by weight per 100 parts by weight of functionalized polyolefin, preferably from about 10 to about 20, and most preferably from 12 to 18.

The carboxylic acid co-surfactant can be any that is known in the art capable of producing a stable functionalized polyolefin emulsion. While not intended to be bound by any particular theory, the carboxylic acid co-surfactant is neutralized by the neutralizing base to form an anionic surfactant species.

In one embodiment of the invention, the carboxylic acid co-surfactant is at least one selected from the group consisting of linear organic carboxylic acids and alicyclic organic carboxylic acids. The term “linear organic carboxylic acid” means any carboxylic acid structure which contains no cyclic or multi-cyclic groups and can include branched structures with no cyclic units. The linear organic carboxylic acid can be any known in the art that can emulsify the functionalized polyolefin to produce a stable functionalized polyolefin emulsion. A stable functionalized polyolefin emulsion was previously defined in this disclosure. Preferred examples of linear organic carboxylic acids include, but are not limited to, linear C₁₆ to C₁₈ fatty acids, such as, for example, oleic, stearic or palmitoleic acid. Saturated carboxylic acids are preferred since they oxidize less than unsaturated carboxylic acids, thereby not affecting the color of the functionalized polyolefin as much as unsaturated carboxylic acids.

Alicyclic organic carboxylic acids can be any known in the art that can emulsify the functionalized polyolefin to produce a stable functionalized polyolefin emulsion. Examples of alicyclic organic carboxylic acid include, but are not limited to, rosin acids. Hydrogenated rosin acids, such as Foral AX-E rosin acid produced by Eastman Chemical Company, are particularly well suited for this invention because of the light color and stability imparted by hydrogenation.

In one embodiment of the invention, when emulsifying a functionalized polyolefin having a grafting level ranging from about 0.5% by weight to about 2.5% by weight grafted functionalizing agent based on the weight of the functionalized polyolefin, the amount of linear organic carboxylic acid is less than or equal to about 16 parts by weight per 100 parts by weight of functionalized polyolefin. Addition of an alicyclic organic carboxylic acid is not needed to obtain a stable functionalized polyolefin emulsion when the amount of the linear organic carboxylic acid is less than or equal to 16 parts by weight per 100 parts by weight of functionalized polyolefin. Preferably, when used alone in the emulsion formulation without an alicyclic carboxylic acid, the amount of linear organic carboxylic acid can range from about 2 to about 16 parts by weight per hundred parts by weight of functionalized polyolefin, most preferably from 8 to 12. It was surprising that the use of high levels of linear organic carboxylic acid hindered emulsification and produced poorer quality emulsions as shown in the examples section.

However, in one embodiment of this invention, when emulsifying functionalized polyolefins having a grafting level ranging from about 0.5% by weight to about 2.5% by weight based on the weight of the functionalized polyolefin and using a linear organic carboxylic acid in an amount less than or equal to 16 parts by weight per hundred parts by weight of functionalized polyolefin, improved emulsion properties, such as transmittance, can be obtained when at least one alicyclic organic carboxylic acid is also utilized in combination with the linear organic carboxylic acid. It is preferred to use mixtures of alicylic organic carboxylic acids with linear organic carboxylic acids when the total level of carboxylic acid co-surfactant in the emulsion is greater than 8 parts by weight per hundred parts by weight of functionalized polyolefin. When using both a linear organic carboxylic acid and alicyclic organic carboxylic acid, the total amount of carboxylic acid co-surfactant in the functionalized polyolefin emulsion is preferably in the range from about 8 parts by weight to about 25 parts by weight per hundred parts by weight of functionalized polyolefin, most preferably, from 10 to 16. To obtain these improved emulsion properties, the amount of the alicyclic organic carboxylic acid can range from about 1% by weight to about 99% by weight of the total amount of carboxylic acid co-surfactant, preferably from 25% by weight to 75% by weight.

In another embodiment of this invention, it has been found that when the amount of total organic carboxylic acid is greater than 16 parts by weight per 100 parts by weight of functionalized polyolefin for functionalized polyolefins with grafting levels between about 0.5 to about 2.5% by weight functionalizing agent based on the weight of the functionalized polyolefin, the addition of alicyclic organic carboxylic acid, such as rosin acid, aids in the emulsification of the functionalized polyolefin whereas further addition of linear organic carboxylic acid above 16 parts per hundred parts of resin deteriorates emulsion quality. In one embodiment of this invention, when the total amount of carboxylic acid co-surfactant is greater than 16 parts by weight per hundred parts by weight of functionalized polyolefin, the maximum amount of linear organic carboxylic acid should be 16 parts by weight per hundred parts by weight functionalized polyolefin and the remainder of the carboxylic acid co-surfactant should be alicylic organic carboxylic acid.

In another embodiment of this invention, the carboxylic acid co-surfactant is at least one alicyclic organic carboxylic acid. The amount of the alicyclic organic carboxylic acid is that which is sufficient to produce a stable functionalized polyolefin emulsion. In one embodiment of the invention, the amount of the alicyclic organic carboxylic acid can range from about 5 parts by weight to 25 parts by weight per hundred parts by weight of functionalized polyolefin, preferably from 10 parts by weight to 16 parts by weight.

To emulsify the functionalized polyolefin, a neutralizing base is also used. While not intended to be bound by any particular theory, it is believed that the neutralizing base neutralizes the carboxylic acid-co-surfactant to form a soap which acts as an emulsifier for the process of the invention. It is also believed that the neutralizing base neutralizes functional groups on the functionalized polyolefin. Preferred bases are organic compounds having 1 to about 10 carbon atoms, an amino group, and a hydroxyl group. Preferred bases include, but are not limited to, N,N-diethylethanolamine, N,N-dimethyl ethanolamine, 2-dimethylamino-2-methyl-1 propanol, 2-dimethylamino-1-propanol, or combinations thereof.

Additionally, when a maleated polypropylene emulsion is dried, the neutralizing base can be volatile enough that it evaporates, which can allow the anhydride group in the maleated polypropylene to reform at higher temperatures. This behavior can be important in fiberglass sizing applications because the emulsion size can be reconverted to the anhydride form during drying, allowing the maleated polypropylene to also serve as coupling agent directly deposited onto the glass fiber.

The amount of neutralizing base is that which is sufficient to convert a portion of the carboxylic acid co-surfactant to an anionic surfactant and to neutralize a portion of the acid groups of the functionalized polyolefin. Generally, the amount of the neutralizing base in the functionalized polyolefin emulsion is not a fixed amount but depends on the total acidity of the functionalized polyolefin emulsion where the acidity is the combination of the carboxylic acid co-surfactant and the acidity of the grafted functional groups and the acidity of any emulsion additives. It is preferred that enough base be used to neutralize about 80% to 100% of the total acidity in the emulsion.

The remainder of the functionalized polyolefin emulsion is water.

In another embodiment of this invention, the functionalized polyolefin emulsion utilized comprises at least one functionalized polyolefin, at least one non-ionic surfactant, at least one neutralizing base, at least one carboxylic acid co-surfactant, and water; wherein the functionalized polyolefin has a grafting level from about 0.5% by weight to about 2.5% by weight functionalizing agent based on the weight of the functionalized polyolefin; and wherein the carboxylic acid co-surfactant comprises at least one alicyclic carboxylic acid.

The functionalized polyolefin and at least one neutralizing base were previously discussed in this disclosure.

The non-ionic surfactant was also previously discussed in this disclosure and is selected based on the graft level of the functionalized polyolefin.

The carboxylic acid co-surfactant is at least one alicyclic organic carboxylic acid. Alicyclic organic carboxylic acids were discussed previously in this disclosure. In another embodiment of this invention, the carboxylic acid co-surfactant is at least one linear organic carboxylic acid and at least one alicyclic organic carboxylic acid.

In another embodiment of this invention, the functionalized polyolefin emulsion utilized comprises at least one functionalized polyolefin, at least one non-ionic surfactant, at least one neutralizing base, at least one carboxylic acid co-surfactant, and water; wherein the functionalized polyolefin has a grafting level from about 0.5% by weight to about 2.5% by weight functionalizing agent based on the weight of the functionalized polyolefin; and wherein the functionalized polyolefin emulsion has a % transmittance of at least 5%. The functionalized polyolefin emulsion can also have good filterability. Good filterability is defined subsequently in the examples section of this disclosure.

In one embodiment of the invention, the size of the emulsion particles is so fine that that the functionalized polyolefin emulsion can be filtered easily to produce a very clean product for making fine coatings. Particles larger than the pores of a filter element cause the filter to become clogged, making filtration very difficult. The functionalized polyolefin emulsion has good filterability if it passes the filterability test described subsequently in this disclosure.

Generally, the functionalized polyolefin emulsions have a transmittance values greater than 5%, preferably greater than 15%, and most preferably greater than 30%.

It is highly desirable that maleated polypropylene emulsions exhibit transmittance values greater than 5%, preferably greater than 10%, more preferred are maleated polypropylene emulsions with a transmittance greater than 20%, while the most desirable maleated polypropylene emulsions exhibit transmittance values greater than 30%. Emulsions of maleated polypropylene can be made which exhibit transmittance values of 60% or greater, particularly if the polypropylene is maleated to a higher degree usually having a grafting level of greater than 2%. Maleated polypropylene emulsions with transmittance values ranging from about 20% to about 35% or higher typically exhibit the coating and filtration behavior desired for emulsions of this type.

The functionalized polyolefin emulsion of this invention can be produced by any method known in the art. In one embodiment of the invention, the functionalized polyolefin emulsion is produced by a process comprising heating at least one functionalized polyolefin, at least one non-ionic surfactant, at least one neutralizing base, at least one carboxylic acid co-surfactant, and water to produce said functionalized polyolefin emulsion; wherein the functionalized polyolefin has a grafting level ranging from about 0.5% by weight to about 2.5% by weight based on the weight of the functionalized polyolefin; wherein the non-ionic surfactant has a HLB ranging from about 4 to about 10; and wherein the carboxylic acid co-surfactant comprises at least one linear organic carboxylic acid in an amount less than or equal to 16 parts by weight per hundred parts by weight of said functionalized polyolefin.

In another embodiment of this invention, the functionalized polyolefin emulsion is produced by a process comprising heating at least one functionalized polyolefin, at least one non-ionic surfactant, at least one neutralizing base, at least one carboxylic acid co-surfactant, and water to produce said functionalized polyolefin emulsion; wherein the functionalized polyolefin has a grafting level ranging from about 0.5% by weight to about 2.5% by weight based on the weight of the functionalized polyolefin; wherein the non-ionic surfactant has a HLB ranging from about 4 to about 10; wherein the carboxylic acid co-surfactant comprises at least one linear organic carboxylic acid and at least one alicyclic organic carboxylic acid; and wherein the amount of total organic carboxylic acid co-surfactant is in an amount greater than 16 parts by weight per hundred parts by weight of the functionalized polyolefin.

In another embodiment of this invention, the functionalized polyolefin emulsion is produced by a process comprising heating at least one functionalized polyolefin, at least one non-ionic surfactant, at least one neutralizing base, at least one carboxylic acid co-surfactant, and water to produce the functionalized polyolefin emulsion, wherein the carboxylic acid co-surfactant comprises at least one alicyclic carboxylic acid.

In another embodiment of this invention, a process is provided to produce a functionalized polyolefin emulsion comprising heating at least one functionalized polyolefin, at least one non-ionic surfactant, at least one neutralizing base, at least one carboxylic acid co-surfactant, and water to produce said functionalized polyolefin emulsion; wherein the functionalized polyolefin has a grafting level from about 0.5% by weight to about 2.5% by weight; and wherein the functionalized polyolefin emulsion has a % transmittance of at least 5%.

In all of these processes described previously to produce functionalized polyolefin emulsions, the emulsions can be produced by either a direct or indirect method. In a direct or batch method, the functionalized polyolefin, at least one non-ionic surfactant, at least one neutralizing base, at least one carboxylic acid co-surfactant, and water are added to an emulsification vessel at the start of the batch to produce an emulsification mixture. The emulsification vessel is then heated to the desired emulsification temperature under the vapor pressure of the water. The temperature of the emulsification mixture is generally above the melting point of the functionalized polyolefin. The temperature of the emulsification mixture can range from about 140° C. to about 185° C., prefererably from 165° C. to 180° C. and depends strongly on the melting point of the functional polyolefin.

An advantage of the direct method is there is no need to charge materials to the emulsification vessel while it is under pressure. In addition, it is simple process that eliminates additional steps that add cost to the production of the functionalized polyolefin emulsion.

In the indirect method, first, the functionalized polyolefin and a portion of at least one of the other emulsion ingredients are heated above the melting point of the functionalized polyolefin. Then, the remaining emulsion ingredients are added in any order or combination at elevated temperatures.

In another embodiment of the invention, the alicyclic carboxylic acid can be incorporated in the functionalized polyolefin during the production of the functionalized polyolefin, compounded with the functionalized polyolefin, or added at any time in the emulsification process.

The phosphorous-based oxo acid moiety is any phosphorous-based oxo acid moiety having a phosphorous oxidation state of 4 or lower. Examples of phosphorous-based oxo acid moieties include, but are not limited to, phosphorous acid, hypophosphorous acid, and neutralized salts of these acids. When the functionalized polyolefin is maleated polypropylene, the preferred phosphorous-based oxo acid moiety is hypophosphorous acid.

The sulfur-based oxo acid moiety is any sulfur-based oxo acid moiety having a sulfur oxidation state of 4 or lower. Examples of the sulfur-based oxo acid moiety include, but are not limited to, sodium sulfite and sodium metabisulfite. Other sulfur-based oxo acid moieties which can behave synergistically with the phosphorous-based oxo acid moiety to improve heat aged color can also be utilized. When the functionalized polyolefin is maleated polypropylene, the preferred sulfur-based oxo acid moiety is sodium metabisulfite.

The amount and type of phosphorous-based oxo acid moiety and sulfur-based oxo acid moiety required to achieve heat aged color stability in functionalized polyolefin emulsions are not fixed or predictable values, but depends to a large extent on the grafting level of the functionlized polyolefin and the color body impurities contained therein. Also, the emulsion ingredients and production procedure influence the heat stability or heat aged color of the emulsion to an extent.

The amount of the phosphorous-based oxo acid moiety can range from about 0.1 parts by weight to about 3 parts by weight per hundred parts by weight of functionalized polyolefin in the emulsion, preferably from about 0.1 parts by weight to about 1 part by weight, and most preferably from 0.2 parts by weight to 0.6 parts by weight. When the functionalized polyolefin is maleated polypropylene, the amount of the phosphorous-based oxo acid moiety can range from about 0.1 parts by weight to about 3 parts by weight per hundred parts by weight of functionalized polyolefin, preferably from about 0.1 parts by weight to about 1 part by weight, and most preferably from 0.2 parts by weight to 0.9 parts by weight.

The amount of the sulfur-based oxo acid moiety can range from about 0.1 parts by weight to about 3 parts by weight per hundred parts by weight of functionalized polyolefin in the emulsion, preferably from about 0.2 parts by weight to about 1 part by weight, and most preferably from 0.2 parts by weight to 0.6 parts by weight. When the functionalized polyolefin is maleated polypropylene, the amount of the sulfur-based oxo acid moiety can range from about 0.1 parts by weight to about 3 parts by weight per hundred parts by weight of functionalized polyolefin in the emulsion, preferably from about 0.2 parts by weight to about 1 part by weight, and most preferably from 0.2 parts by weight to 0.6 parts by weight.

Preferred functionalized polyolefins for producing heat stable, functionalized polyolefin emulsions are those manufactured to produce light color and contain the lowest amount of color body precursors which can darken due to oxidation during heat aging. The yellowness index of the functionalized polyolefin can be up to 50, preferably less than 40. To achieve this target for maleated polypropylene, it is preferred that the maleated polypropylene contain less than about 2.0% by weight grafted maleic anhydride based on the weight of the maleated polypropylene and exhibit an acid number due to grafting less than about 11 mg KOH/g. The amount of polyolefin degradation increases with increasing graft level.

In one embodiment of the invention, if the functionalized polyolefin has a yellowness index of less than 40, it can be stabilized to achieve a Gardner color of less than or equal to 6 when heat aged by the addition of only the phosphorous-based oxo acid moiety without the sulfur-based oxo acid moiety. However, it is generally found that the additional sulfur-based oxo acid moiety can further improve the heat aged color of the functionalized polyolefin emulsion.

Other additives can also be included in the functionalized polyolefin emulsion to further improve color including, but not limited to, antioxidants, optical brighteners, and colorants.

Antioxidants include any compounds known in the art capable of reducing degradation of the functionalized polyolefin. Antioxidants include, but are not limited to, phosphites and thiodipropioniate esters. Specific commercial examples include, but are not limited to, Weston 619 antioxidant obtained from General Electric and di-laurylthiodiproprionate (DLTDP) obtained from Crompton. However, antioxidants in the absence of the phosphorous-based oxo acid moiety are not able to improve heat aged color of the functionalized polyolefin emulsions to yield a Gardner color less than or equal to 6.

Optical brighteners can be any compound known in the art to improve the color of the functionalized polyolefin emulsions. Examples of optical brighteners are given in Plastics Additives, Gachter/Muller, 3^{rd} Edition, Hansen Publishers, 1990, herein incorporated by reference. A specific example of a commercial optical brightener is OB-1 Optical Brightener obtained from Eastman Chemical Company. The effect of the optical brightener can be perceived visually by the human eye if a phosphorous-based oxo acid moiety, sulfur-based oxo acid moiety, and antioxidant are also added to the functionalized polyolefin emulsion.

In a preferred embodiment, the functionalized polyolefin emulsion can contain between about 0.2 parts by weight to about 0.8 parts by weight hypophosphorous acid (neat basis) based on the weight of the functionalized polyolefin in the emulsion, about 0.2 parts by weight to about 0.6 parts by weight sodium metabisulfite based on the weight of the functionalized polyolefin in the emulsion, and at least one secondary phosphite or thiodiproprionate ester antioxidant. The functionalized polyolefin emulsion can also include at least one optical brightener in an amount ranging from about 10 ppm by weight to about 100 ppm by weight based on the weight of the functionalized polyolefin in the emulsion.

In these emulsion formulations, each of these additives contributes an additional improvement in heat aged color relative to the emulsion formulation without the additive, but the desired heat aged color stability cannot be achieved without the addition of low levels of at least one phosphorous-based oxo acid moiety. Any combination of sodium metabisufite, secondary antioxidant, and optical brightener does not provide the superior color stability consistently achieved when a phosphorous-based oxo acid moiety is included in the emulsion formulation. Alternatively, other sulfur-based oxo acid moieties, such as sodium sulfite, may behave synergistically with the phosphorous-based oxo acid moiety to impart good heat age color stability to the functionalized polyolefin emulsions.

In another embodiment of this invention, a process is provided to produce a heat stable, functionalized polyolefin emulsion. The process comprises adding at least one additive to a functionalized polyolefin emulsion wherein the additive comprises at least one phosphorous-based oxo acid moiety. The additive can further comprise at least one sulfur-based oxo acid moiety.

In another embodiment of this invention, a process is provided to produce a heat stable, functionalized polyolefin emulsion. The process comprising contacting at least one functionalized polyolefin, at least one non-ionic surfactant, at least one carboxylic acid co-surfactant, at least one neutralizing base, water, and at least one additive to produce a heat stable functionalized polyolefin emulsion; wherein the additive comprises at least one phosphorous-based oxo acid moiety. The additive can further comprise at least one sulfur-based oxo acid moiety.

In any of these processes, the additive can be added during the production of the emulsion, after the production of the emulsion, or a portion of the additive can be added both during and after the production of the emulsion.

### EXAMPLES

This invention can be further illustrated by the following examples of preferred embodiments thereof, although it will be understood that these examples are included merely for purposes of illustration and are not intended to limit the scope of the invention unless otherwise specifically indicated.

Test Methods

Heat aged color of the functionalized polyolefin emulsions were measured by the following standard procedure. 12.0 grams of maleated polypropylene emulsion were weighed into each 9 cm (I.D.) Pyrex culture dish with nominal 1 cm height. The set of emulsion samples in Pyrex dishes was placed in a forced air oven at a temperature of 182° C.+/−1° C. and conditioned for 50 minutes. The air flow and heating capacity of the oven were sufficient that after 12 to 15 minutes in the oven each of the emulsions was completely dry and in the full molten state with the air temperature at 182° C.+/−1° C.

After the conditioning time, equivalent to about 30+ minutes (minimum) in the full dry, molten state at 182° C.+/−1° C., the pyrex dishes were removed with forceps and placed on a water bath for 2 seconds and then fully immersed in the water to quench cool the molten emulsion to produce emulsion films. The emulsion films were removed from the dishes and dried.

The yellowness index and b* value of each of the emulsion films were measured using a Hunter Ultra-Scan spectrophotometer measuring (4) random areas of the emulsion film where the thickness was >17 mils. The Hunter Ultra-Scan spectrophotometer was calibrated according to the instrument manual.

Visual Gardner color was measured using a Gardner color wheel color comparator used typically to measure the color of hydrocarbon resins and rosin resins.

Emulsification of the Functionalized Polyolefin

The following procedure was used to emulsify Epolene G-3003 maleated polypropylene produced by Eastman Chemical Company. Epolene G-3003 maleated polypropylene has a grafting level of about 1.4% by weight maleated anhydride based on the weight of the maleated polypropylene. Table 1 shows a typical recipe for the Epolene G-3003 maleated polypropylene emulsions used in the examples. All of the following ingredients were added to a 300 cc Parr pressure reactor.

TABLE 1

| | |
|---|---|
| Water | 65.0% |
| DMAMP-80 | 2.6% |
| Foral AX-E rosin acid | 2.4% |
| Oleic Acid | 1.1% |
| Brij 30 surfactant | 3.1% |
| Brij 72 surfactant | 1.5% |
| Epolene G-3003 | 24-26% |
| Process Stabilizer | 0%-0.4% |

The neutralization base was 2-dimethylamino-2-methylpropanol (DMAMP-80) used as an 80% by weight solution (20% water). Foral AX-E is a hydrogenated rosin acid obtained from Eastman Chemical Company. Brij 30 and Brij 72 surfactants are non-ionic surfactants obtained from Uniquema Chemical Company. The ingredients were heated with vigorous stirring under pressure to about 178° C. to produce a maleated polypropylene emulsion. The emulsion was stirred with vigorous agitation for 60 minutes at 178° C. Then, the maleated polypropylene emulsion was cooled to 130° C. at about 2° C. per minute. Finally, the emulsion was cooled to 50° C. at about 5° C. to 10° C. per minute cooling rate, and the emulsion was then discharged through a fine paint strainer to remove solids.

Various maleated polypropylene emulsions were made using this procedure in order to measure the effect of various additives on the heat aged color development in the dried emulsion. A 50/50 mix of Weston 619 antioxidant obtained from General Electric and DLTDP antioxidant obtained from Crompton was utilized in examples where antioxidants were added. The amount of all the additives in the subsequent Tables are given in weight percent based on the weight of the maleated polypropylene emulsion.

### COMPARATIVE EXAMPLES 1-2, INVENTIVE EXAMPLES 1-3

In Comparative Example 1 in Table 2, a maleated polypropylene emulsion was produced where the additive utilized was only a secondary anti-oxidant. Comparative Example 2 in Table 2 utilized 0.2% by weight secondary antioxidant and 0.14% by weight sodium metabisulfite as additives. In Example 1, 0.2% by weight secondary antioxidant and 0.11% by weight hypophosphorous acid (neat basis) was added as the additives. Example 2 used the same additives as Example 1 but with 0.09% sodium metabisulfite. Example 3 was very similar to Example 2 but contained 25 ppm Eastman OB-1 optical brightner as an stabilizer additive. The heat aged color values of the conditioned emulsion films were measured and tabulated in Table 2.

Comparative Example 1 containing only secondary antioxidant and Comparative Example 2 containing only secondary antioxidant and 0.14% by weight sodium metabisulfite exhibited dark heat aged color of about G8.

In contrast, Inventive Example 1 containing only hypophosphorous acid and secondary antioxidant exhibited a lighter Gardner color of G5. Example 2 containing the same additives as Example 1 plus an additional 0.09% sodium metabisulfite exhibited a further improved Gardner color of G3+ due to the addition of sodium metabisulfite in combination with the hypophosphorous acid. Example 3 with the same additives as Example 2 with additionally 25 ppm Eastman OB-1 optical brightner exhibited a further improved heat aged color of G2.

In summary, emulsions of Epolene G-3003 maleated polypropylene containing only the standard sodium metabisulfite additive typically specified for this type of emulsion exhibited poor heat aged color while the Inventive Examples containing hypophosphorous acid as an emulsion additive exhibited very good heat aged color.

TABLE 2

| | Comparative | Comparative | | | |
|---|---|---|---|---|---|
| | Example 1 | Example 2 | Example 1 | Example 2 | Example 3 |
| Maleated PP Type | G-3003 | G-3003 | G-3003 | G-3003 | G-3003 |
| Process Stabilizer | | | | | |
| Sodium Metabisulfite | None | 0.14% | — | 0.09% | 0.09% |
| Hypophosphorus Acid (net basis) | None | — | 0.11% | 0.11% | 0.11% |
| Optical Brightner | — | — | — | — | 25 ppm |
| Secondary Antioxidant | 0.20% | 0.20% | 0.20% | 0.20% | 0.15% |
| Heat Aged Color | | | | | |
| Yellowness Index (Avg.) | 26.8 | 26.4 | 12.8 | 8.7 | 3.9 |
| (Range) | 25.1-29.5 | 24-29.3 | 12.4-13.1 | 8.3-9.3 | 2.4-4.2 |
| b* (Avg.) | 14.3 | 13.5 | 6.4 | 4.3 | 1.9 |
| (Range) | 13.4-15.6 | 12.2-14.9 | 6.2-6.5 | 4.0-4.5 | 1.6-1.9 |
| Gardner Color Appearance | G7+ or G8 | G8 | G5 | G3+ | G2 |

### COMPARATIVE EXAMPLES 3 AND 4, INVENTIVE EXAMPLES 4-5

Comparative Example 3 in Table 3 lists the heat aged color of an emulsion of Eastman Epolene E-43, a low molecular weight, maleated polypropylene wax, which exhibited a dark heat aged color of about G10. Similarly, in Comparative Example 4, a standard emulsion of high molecular weight Eastman Epolene G-3015 maleated polypropylene having a weight average molecular weight of 50,000 and a graft level of about 3% by weight maleic anhydride based on the weight of the maleated polypropylene containing only sodium metabisulfite as a additive exhibited a dark G12 heat aged color. In contrast, in Example 4, the same Epolene G-3015 maleated polypropylene emulsion containing 0.11% hypophosphorous acid in addition to 0.09% sodium metabisulfite exhibited greatly reduced heat aged color to G5 while in Example 5 the addition of a low level of optical brightner and secondary antioxidant improved the heat aged color only a shade relative to Example 4.

In contrast, the addition of 25 ppm by weight of optical brightener to an Epolene G-3003 emulsion which exhibited very light heat aged color (Examples 2 and 3) caused a much more perceptible reduction in color, decreasing yellowness index from 8.7 to about 4, which is easily noted by the eye. Optical brightener additives are most effective in improving the visual “whiteness” of a material when there are only a limited amount of color bodies to counteract. In cases where the emulsion film is substantially yellowed, the effect of the optical brightner is limited, while in cases where the emulsion film is pale in color without the optical brightener, the optical brightener can impart a more perceptible improvement in color.

TABLE 3

| | Comparative | Comparative | | | | |
|---|---|---|---|---|---|---|
| | Example 3 | Example 4 | Example 4 | Example 5 | Example 2 | Example 3 |
| Maleated PP Type | Epolene | Epolene | Epolene | Epolene | Epolene | Epolene |
| | E-43 | G-3015 | G-3015 | G-3015 | G-3003 | G-3003 |
| Process Stabilizer | | | | | | |
| Sodium Metabisulfite | 0.30% | 0.11% | 0.09% | 0.09% | 0.09% | 0.09% |
| Hypophosphorus Acid (net basis) | None | — | 0.11% | 0.11% | 0.11% | 0.11% |
| Optical Brightner | — | — | — | 25 ppm | — | 25 ppm |
| Secondary Antioxidant | — | — | — | 0.15% | 0.20% | 0.15% |
| Heat Aged Color | | | | | | |
| Yellowness Index (Avg.) | 40.2 | 35.6 | 12.8 | 10.5 | 8.7 | 3.9 |
| (Range) | 35-46 | 30.3-39.0 | 12.4-13.1 | 10.2-11.1 | 8.3-9.3 | 2.4-4.2 |
| b* (Avg.) | 19 | 18.9 | 6.4 | 5.5 | 4.3 | 1.9 |
| (Range) | 17.0-21.6 | 16.1-21.0 | 6.2-6.5 | 5.4-5.8 | 4.0-4.5 | 1.6-1.9 |
| Gardner Color Appearance | G10 or G11 | G12 | G5 | G5− | G3+ | G2 |

### INVENTIVE EXAMPLES 6-8

Inventive Example 6 in Table 4 lists the heat aged color properties of an Epolene G-3003 emulsion where 0.20% of a secondary antioxidant and 0.11% hypophosphorus acid and 0.11% sodium metabisulfite were added as the additives. A very good heat aged color of G3 was measured. Inventive Example 7 compared a very similar emulsion differing only in that no secondary antioxidant was present. The heat aged color was only slightly darker than the case in Example 6, demonstrating that the secondary antioxidant plays a limited role in minimizing color during heat aging, but is desirable as an additive in order to achieve the most stable type of maleated polypropylene emulsion.

In Inventive Example 8 in Table 4, a standard emulsion was made from Eastman Epolene G-3003 maleated polypropylene where both a secondary antioxidant and optical brightener were compounded with the maleated polypropylene before emulsification, and the emulsion contained effective amounts of hypophosphorus acid and sodium metabisulfite to achieve good heat aged color. In comparison, in Inventive Example 3, the same additives at the same level were present in the emulsion except that both the optical brightener and secondary antioxidant were added during the emulsification step and not pre-compounded into the maleated polypropylene. The results showed no significant difference in heat aged color between the two cases indicating that auxiliary additives, such as optical brighteners and secondary antioxidants, can be effectively incorporated during the emulsification step and need not be previously incorporated into the maleated polypropylene.

TABLE 4

| | Comparative | | | | |
|---|---|---|---|---|---|
| | Example 1 | Example 6 | Example 7 | Example 8 | Example 3 |
| Maleated PP Type | G-3003 | G-3003 | G-3003 | G-3003 | G-3003 |
| Process Stabilizer | | | | | |
| Sodium Metabisulfite | None | 0.11% | 0.11% | 0.11% | 0.11% |
| Hypophosphorous Acid (net basis) | None | 0.11% | 0.11% | 0.11% | 0.11% |
| Optical Brightner | — | — | — | 25 ppm | 25 ppm |
| Secondary Antioxidant | 0.20% | 0.20% | — | 0.20% | 0.15% |
| Heat Aged Color | | | | | |
| Yellowness Index (Avg.) | 26.3 | 6.7 | 7.75 | 5.1 | 4.6 |
| (Range) | 25.1-27.1 | 5.7-7.3 | 7.1-8.4 | 4.8-5.5 | 3.6-5.1 |
| b* (Avg.) | 13.6 | 3.3 | 3.8 | 2.3 | 2.2 |
| (Range) | 13.0-14.1 | 2.8-3.6 | 3.5-4.1 | 2.3-2.5 | 1.7-2.4 |
| Gardner Color Appearance | G7+ or G8 | G3 | G3+ | G2 | G2 |

### COMPARATIVE EXAMPLE 5, INVENTIVE EXAMPLES 9-12

In Comparative Example 5 in Table 5, an emulsion was prepared from Epolene G-3003 maleated polypropylene where 0.14% phosphorous acid was added as a additive. The heat aged color was measured to be G8. In Inventive Example 9, a similar emulsion containing additionally 0.09% sodium metabisulfite and 0.2% secondary antioxidant was tested in the heat aging procedure and a lighter color of G5 was measured. In Inventive Example 10, a similar emulsion was prepared where 0.11% sodium sulfite was substituted for the sodium metabisulfite in the emulsion. The results for Inventive Example 10 were very similar to the heat aged color of Inventive Example 9 indicating no particular advantage or disadvantage in the use of sodium sulfite over sodium metabisulfite. In Inventive Example 11, a comparable Epolene G-3003 emulsion was made containing 0.11% by weight hypophosphous acid and 0.13% by weight sodium metabisulfite as additives in the emulsion. The heat aged color was measured to be G3, greatly improved over comparable Example 9 where phosphorous acid was used as the emulsion stabilizer. Although phosphorous acid in combination with sodium metabisulfite or similar additive can give good heat aged color in high molecular weight maleated polypropylene emulsions, better color results can be observed using hypophosphorus acid as the phosphorous-based oxo acid.

In Inventive Example 12, an Epolene G-3003 maleated polypropylene emulsion containing 0.13% sodium sulfite in addition to hypophosphorus acid was prepared. The heat aged color of about G3+ was observed which is lighter than the heat aged color in Example 1 where the emulsion contained only hypophosphorus acid and no sulfur-based oxo acid moiety. However, the heat aged color was marginally inferior to the result in Example 11 where sodium metabisulfite was used as the sulfur-based oxo acid moiety. Therefore, sodium metabisulfite is the preferred sulfur-based oxo acid moiety for use with hypophosphorus acid in emulsions of high molecular weight maleated polypropylene in order to retain good color properties after heat aging.

TABLE 5

| | Comparative | | | | |
|---|---|---|---|---|---|
| | Example 5 | Example 9 | Example 10 | Example 11 | Example 12 |
| Maleated PP Type | G-3003 | G-3003 | G-3003 | G-3003 | G-3003 |
| Process Stabilizer | | | | | |
| Sodium Metabisulfite | — | 0.09% | — | 0.13% | — |
| Sodium Sulfite | — | — | 0.11% | — | 0.13% |
| Phosphorous Acid | 0.14 | 0.14% | 0.14% | — | — |
| Hypophosphorous Acid (net basis) | — | — | — | 0.11% | 0.11% |
| Optical Brightner | — | — | — | — | — |
| Secondary Antioxidant | — | 0.20% | — | — | — |
| Heat Aged Color | | | | | |
| Yellowness Index (Avg.) | 20.1 | 10.8 | 10.7 | 6.9 | 9.1 |
| (Range) | 18.3-21.1 | 9.5-11.9 | 9.4-12.7 | 6.6-7.8 | 7.5-9.9 |
| b* (Avg.) | 10.2 | 5.5 | 5.5 | 3.5 | 4.6 |
| (Range) | 9.9-10.7 | 4.7-5.8 | 4.8-6.5 | 3.3-3.9 | 3.8-5.0 |
| Gardner Color Appearance | G8 | G5 or G5+ | G5+ | G3 | G3+ or G4− |

### EXAMPLES 13-19

### Use of Additives In Maleated Polypropylene Emulsions To Improve Color

In Example 13, a maleated polypropylene product was made by the procedure used to manufacture Epolene G-3003 maleated polypropylene where the reactant flows (maleic anhydride and peroxide) were increased by 15% to produce a material having a graft level nominally 15% greater than the level present in standard Epolene G-3003 maleated polypropylene manufactured by Eastman Chemical Co. and characterized by an acid number value of 10.5 mg KOH/g. This maleated polypropylene made by this procedure is listed as G-3003× in Table 6.

In Examples 14 through 17 in Table 6, maleated polypropylene emulsions were made from conventional Epolene G-3003 maleated polypropylene produced by Eastman Chemical Company having a nominal 9 mg KOH/g. acid number where the maleated polypropylene emulsion was made by a direct method with stirring at 172° C. The ingredients used to emulsify the maleated polypropylene are listed in Table 6. The emulsion formulations were very similar, the only difference being that Example 14 contained no hypophosphorous acid (HPA) and potassium hydroxide (KOH). Example 15 contained low levels of hypophosphorous acid and sodium metabisulfite. Example 16 contained two times the amount of HPA+KOH as Example 15, and Example 17 contained three times the amount of additive as Example 15. All the maleated polypropylene emulsions were very good quality with no residue and fast filtration characteristics. The transmittance values of the formulations were very sensitive to the amount of HPA and KOH in the maleated polypropylene emulsion, with little increase between Examples 16 and 17.

Commercial Epolene G-3003 maleated polypropylene produced by Eastman Chemical Company can be effectively emulsified according to the procedures described herein. The addition of low levels of potassium hydroxide neutralized hypophosphorous acid or hypophosphorous acid alone to the emulsion formulation can serve both as a stabilizer to improve the heat aged color of the maleated polypropylene emulsion and also to improve the quality of the emulsion, increasing the transmittance of the emulsion.

The maleated polypropylene of Example 13 was emulsified by a direct method using the ingredients listed in Table 6. In Example 18, no hypophosphorous acid was added to the emulsion charge while in Example 19, hypophosphorous acid and KOH were added at the levels indicated. There was no significant increase in transmittance values for the maleated polypropylene emulsions of Examples 18 and 19 due to the addition of the hypophosphorous acid color stabilizer. Commercial Epolene G-3003 maleated polypropylene can be emulsified well according to the procedures described herein, but increasing the maleation of the maleated product by only about 15% to 25% can improve emulsification characteristics further and make the emulsification procedure less sensitive to small changes in formulation or additional ingredients.

TABLE 6

| | Example No. | | | | | |
|---|---|---|---|---|---|---|
| | 14 | 15 | 16 | 17 | 18 | 19 |
| Maleated PP | G-3003 | G-3003 | G-3003 | G-3003 | G-3003X | G-3003X |
| (%) | 26 | 26 | 26 | 26 | 26 | 26 |
| Non-ionic Surfactant | 4.3% | 4.3% | 4.3% | 4.3% | 4.3% | 4.3% |
| HLB | 9.0 | 9.0 | 9.0 | 9.0 | 9.5 | 9.5 |
| Foral AX-E | 1.4% | 1.4% | 1.4% | 1.4% | 1.4% | 1.4% |
| Oleic Acid | 1.8% | 1.8% | 1.8% | 1.8% | 1.8% | 1.8% |
| DMAMP-80 | 2.4% | 2.4% | 2.4% | 2.4% | 2.6% | 2.6% |
| 50% Hypophosphorous Acid | — | 0.11% | 0.23% | 0.36% | — | 0.23% |
| Potassium Hydroxide | — | 0.05% | 0.10% | 0.15% | — | 0.10% |
| Sodium Metabisulfite | 0.10% | 0.10% | 0.10% | 0.10% | 0.10% | 0.10% |
| Residue | None | None | None | None | None | None |
| Filtration Speed | V. Fast | V. Fast | V. Fast | V. Fast | V. Fast | V. Fast |
| % Transmittance | 15.6 | 27.4 | 38.5 | 41.2 | 43.3 | 46.5 |

### EXAMPLES 20-23

### Use of Saturated Fatty Acids as Carboxylic Acid Co-Surfactants in Maleated Polypropylene Emulsions

As described above in Example 16, a maleated polypropylene emulsion was made from standard Eastman Epolene G-3003 maleated polypropylene using both Foral AX-E rosin acid and oleic acid as carboxylic acid co-surfactants. In Example 20, a similar maleated polypropylene emulsion was prepared where the unsaturated oleic acid was replaced by stearic acid. An excellent emulsion resulted with transmittance values even higher than for Example 16 using oleic acid. In Example 21, a maleated polypropylene emulsion was prepared in the same manner as in Example 20 but where ⅓ of the Foral AX-E rosin acid in the charge was also replaced by an equal amount of stearic acid. Again, an excellent emulsion resulted with similar properties as the previous two maleated polypropylene emulsions. These examples serve to demonstrate that the straight chain fatty acid used in this invention can be saturated types of fatty acids which are typically crystalline waxes in their pure state. Being saturated and less susceptible to oxidation can be an advantage for this type of carboxylic acid co-surfactant when color stability is important.

In previous Example 19, a maleated polypropylene according to Example 13, similar to Eastman Epolene G-3003 but having a 15% higher graft level, was emulsified using both Foral AX-E rosin acid and oleic acid as carboxylic acid co-surfactants. In Example 22, a similar maleated polypropylene emulsion was prepared as in Example 19 where the amount of Foral AX-E rosin acid was reduced and the oleic acid was replaced by a mixture of stearic acid and Prisorine 3501 isostearic acid obtained from Uniqema. An excellent emulsion resulted with similar properties as Example 19. In Example 23, a maleated polypropylene emulsion was prepared in the same manner as Example 22 except the amounts of stearic and isostearic acid were reversed so that 78% of the C₁₈ saturated fatty acid was isostearic acid. Again, an excellent emulsion resulted with similar properties as in Examples 19 and 22. Isostearic acid is a branched fatty acid and non-crystallizing. It can be advantageous to use saturated fatty acids which are non-crystallizing in this invention, and it has been demonstrated that they are effective carboxylic acid co-surfactants when used at the levels and according to the limitations of this invention.

TABLE 7

| | Example No. | | | | | |
|---|---|---|---|---|---|---|
| | 16 | 20 | 21 | 19 | 22 | 23 |
| Maleated PP | G-3003 | G-3003 | G-3003 | G-3003X | G-3003X | G-3003X |
| (%) | 26 | 26 | 26 | 26 | 26 | 26 |
| Non-ionic Surfactant | 4.3% | 4.3% | 4.3% | 4.3% | 4.3% | 4.3% |
| HLB | 9.0 | 9.0 | 9.0 | 9.5 | 9.5 | 9.5 |
| Foral AX-E | 1.4% | 1.4% | 0.9% | 1.4% | 0.5% | 0.5% |
| Oleic Acid | 1.8% | — | — | 1.8% | — | — |
| Stearic Acid | — | 1.8% | 2.3% | — | 1.3% | 0.5% |
| Prisorine 3501 Isostearic Acid | — | — | — | — | 0.9% | 1.8% |
| DMAMP-80 | 2.4% | 2.4% | 2.4% | 2.6% | 2.3% | 2.4% |
| 50% Hypophosphorous Acid | 0.23% | 0.26% | 0.23% | 0.23% | 0.23% | 0.40% |
| Potassium Hydroxide | 0.10% | 0.15% | 0.10% | 0.10% | 0.10% | 0.15% |
| Sodium Metabisulfite | 0.10% | 0.10% | 0.10% | 0.10% | 0.10% | 0.10% |
| Residue | None | None | None | None | None | None |
| Filtration Speed | V. Fast | V. Fast | V. Fast | V. Fast | V. Fast | V. Fast |
| % Transmittance | 38.9 | 41.7 | 38.5 | 48.4 | 46.9 | 49.7 |

### EXAMPLES 24-28

### Color Stability of Maleated Polypropylene Emulsions Formulated with Aminosilane

In a sizing formulation for coating glass fibers, the sizing formulation comprises an organosilane and a polymer emulsion; wherein the polymer emulsion acts as a sizing agent. In the present case, where the polymer emulsion comprises a maleated polypropylene, the preferred silane is an aminosilane, most preferably γ-aminopropyltriethoxysilane (APTS). Although not intending to be bound by theory, the silane functionality couples with the glass surface to form an organosilane surface layer coupled to the glass, and the amine group interacts with the grafted maleic groups of the polypropylene in the emulsion and eventually reacts chemically to form covalent bonds with the polypropylene. After drying, the sizing film comprises maleated polypropylene chemically reacted with aminosilane oligomers. The presence of aminosilane dramatically affects the color of the functionalized polypropylene after heat aging. It would be highly desirable to reduce the amount of color development in sizing compositions comprising both functionalized polypropylene emulsion and emulsions combined with aminosilane.

In Example 24, a mixture of 80 parts deionized water, 0.85 part APTS, and 0.40 part Surfonic TDA-3B surfactant obtained from Huntsman Chemical Company was combined and aged for 1 hour at ambient temperature before 20 parts of maleated polypropylene emulsion of Example 14 were added. The maleated polypropylene emulsion prepared in Example 14 contained sodium metabisulfite with no hypophosphorous acid. After combining the ingredients, the formulation was aged for 4 hours before 1.15 grams of the described formulation was deposited on a 1.5 inch×3.0 inch glass slide placed on a level surface to evenly coat the glass surface. The liquid coating was allowed to dry at ambient temperature over several hours leaving a dry coating deposited on the glass slide at a coating weight of 70-75 mg over the surface. The coated glass slides were placed in a forced air oven at 183° C. and conditioned for 35 minutes. At the end of the conditioning, the yellowness of the deposit on the slide was measured using a Hunter Ultra Scan spectrophotometer calibrated according to manufacturer specifications. Three scans were taken over the entire surface of the glass slide to compensate for thickness variations, and the yellowness values, b* and YI, were averaged for the entire coating. The yellowness values are listed in Table 8.

In Example 25, a formulation was made in the manner of Example 24 where the maleated polypropylene emulsion was the emulsion of Example 15 containing 0.055% hypophosphorous acid in addition to 0.10% SMB. These yellowness values for the heat aged coating are listed in Table 8. In Example 26, a similar formulation was made in the manner of Examples 24 and 25 using the maleated polypropylene emulsion of Example 17 containing a high 0.18% level of hypophosphorous acid in addition to SMB. The yellowness measurements of this formulation after heat aging are listed in Table 8.

In Example 27, a formulation was prepared according to the Examples 24 through 26 where the maleated polypropylene emulsion was the emulsion of Example 18, made from maleated polypropylene having a higher graft level. The emulsion contained no hypophosphorous acid. The yellowness values for this formulation after aging are again listed in Table 8. In Example 28, a formulation was prepared in the same manner as the preceeding formulations using the maleated polypropylene emulsion of Example 19 which was similar to the emulsion of Example 27 but contained 0.12% hypophosphorous acid in combination with 0.10% SMB. The yellowness values of this emulsion after aging are listed in Table 8.

In all cases the inclusion of hypophosphorous acid in the formulation improved the color significantly relative to the emulsions without HPA. The stabilizing effect of HPA in emulsion formulations containing aminosilane is not as dramatic as the previous examples where the heat stability of the emulsion polymer without aminosilane was measured after heat aging. However, the reduction in yellowness due to the incorporation of hypophosphorous acid stabilizer in combination with SMB is substantial and will lead to sized glass fibers with less tendency to yellow after heat aging. In the present case the hypophosphorous acid stabilizer was incorporated during the emulsification process. Being water soluble, all or part of the required HPA stabilizer can also be added to the emulsion composition after emulsification or during formulation with additional ingredients. Both methods of stabilizing a high molecular weight functionalized polyolefin emulsion with hypophosphorous acid additive are considered equivalent and part of the invention.

TABLE 8

| | Example No. | | | | |
|---|---|---|---|---|---|
| | 24 | 25 | 26 | 27 | 28 |
| Maleated Polypropylene | 14 | 15 | 17 | 18 | 19 |
| Emulsion | | | | | |
| Maleated Polypropylene | G-3003 | G-3003 | G-3003 | Ex. 15 | Ex. 15 |
| Type | | | | | |
| Additives in Emulsion | | | | | |
| (% by wt.) | | | | | |
| SMB | 0.1 | 0.1 | 0.1 | 0.1 | 0.1 |
| Hypophosphorous Acid | — | 0.055 | 0.18 | — | 0.11 |
| 183° C. Aged Color | | | | | |
| b* | 6.95 | 3.6 | 2.15 | 5.8 | 3.1 |
| YI | 11.9 | 6.2 | 3.7 | 10.1 | 5.4 |

### EXAMPLES 29-35

### Additional Examples With Emulsions Containing Saturated Linear Carboxylic Acids

In Example 29, an aminosilane mixture was prepared consisting of [75 parts deionized water+1.0 part γ-Aminopropyltriethoxysilane (APTS)+0.6 part Pegosperse 100 surfactant (Lonza Chemical)]. After aging the mixture for 1 hour to permit hydrolysis of the silane, 25 parts of the emulsion of Example 14 was added. This emulsion contained no hypophosphorous acid as a stabilizer. A specimen for heat aging was prepared after the combined mixture aged at ambient temperatures for 4 hours by coating a 1.5 inch×3.0 inch glass slide with 0.80 g. of the formulation on a level surface and allowing the formulation to dry for several hours at ambient temperature to form a uniform deposit on the glass surface. This coated glass slide was placed in a forced air oven at 183° C. and conditioned for 30 minutes. The aged specimen was evaluated for yellowness intensity by measuring b* and YI values using a Hunter Ultra Scan spectrophotometer calibrated and operated according to manufacturer instructions. The yellowness values for this aged sample is listed in Table 9.

In Example 30, a formulation containing aminosilane was prepared and tested in the same manner as Example 29 where the maleated polypropylene emulsion was the emulsion of Example 17 which contained hypophosphorous acid as a color stabilizer. In Example 31, a formulation was prepared and tested in the same manner as in 29 where the emulsion was the emulsion of Example 21 which contained hypophosphorous acid and also contained stearic acid as a carboxylic acid co-surfactant to replace the unsaturated oleic acid co-surfactant contained in the prior Example 17. The color values of these coatings after aging are listed in Table 9.

In Example 32, a formulation was prepared in the same manner as example 29 where the emulsion was the emulsion of Example 18. This emulsion was prepared from a maleated polypropylene material having a 15% higher maleation level than in the previous three emulsions, and no hypophosphorous acid was added in the emulsion. In Example 33, a formulation was made and tested in the same manner as in Example 32 using the emulsion of Example 22 which was made from the same maleated polypropylene as Example 17 but contained hypophosphorous acid as an additive and used saturated linear carboxylic acids as co-surfactants. Example 34 was prepared in the same manner as Examples 32 and 33 using the emulsion of Example 23 made from the same maleated polypropylene material as in Examples 32 and 33. Similarly, Example 35 was prepared and tested in the same manner as Examples 32-34 but using the emulsion of Example 19 which contained HPA and used oleic acid as a co-surfactant. The yellowness values measured for each of these formulated emulsions are listed in Table 9.

In all cases the incorporation of hypophosphorous acid in the emulsion formulation significantly reduced the heat aged yellowing of the coated film. Additionally the use of saturated linear carboxylic acid co-surfactants caused an additional small improvement relative to emulsions containing unsaturated oleic acid as the carboxylic acid co-surfactant.

TABLE 9

| | Example No. | | | | | | |
|---|---|---|---|---|---|---|---|
| | 29 | 30 | 31 | 32 | 33 | 34 | 35 |
| Maleated Polypropylene Emulsion | 14 | 17 | 21 | 18 | 22 | 23 | 19 |
| Maleated Polypropylene Type | G-3003 | G-3003 | G-3003 | EX 13 | Ex 13 | Ex 13 | Ex 13 |
| Additives in Emulsion (% by wt.) | | | | | | | |
| SMB | 0.1 | 0.1 | 0.1 | 0.1 | 0.1 | 0.1 | 0.1 |
| Hypophosphorous Acid | — | 0.18 | 0.11 | — | 0.11 | 0.2 | 0.11 |
| Foral AX-E | 1.4 | 1.4 | 0.9 | 1.4 | 0.5 | 0.5 | 1.4 |
| Oleic Acid | 1.8 | 1.8 | — | 1.8 | — | — | 1.8 |
| Stearic/Isostearic Acid | — | — | 2.3 | — | 1.4/0.9 | .5/1.8 | — |
| 183° C. Aged Color | | | | | | | |
| b* | 6.95 | 3.6 | 2.15 | 5.8 | 3.1 | 2.33 | 3.56 |
| YI | 11.9 | 6.2 | 3.7 | 10.1 | 5.4 | 4.1 | 6.1 |

The invention has been described in detail with particular reference to preferred embodiments thereof, but it will be understood that variations and modifications can be effected within the spirit and scope of the invention.

That which is claimed is:

1. A heat stable functionalized polyolefin emulsion comprising at least one additive wherein said additive comprises at least one phosphorous-based oxo acid moiety.

2. A heat stable functionalized polyolefin emulsion according to claim 1 wherein said additive comprises at least one phosphorous-based oxo acid moiety and at least one sulfur-based oxo acid moiety.

3. A heat stable functionalized polyolefin emulsion according to claim 1 wherein said phosphorous-based oxo acid moiety is selected from the group consisting of phosphorous acid, hypophosphorous acid, and neutralized salts of these acids.

4. A heat stable functionalized polyolefin emulsion according to claim 3 wherein said phosphorous-based oxo acid moiety is hypophosphorous acid.

5. A heat stable functionalized polyolefin emulsion according to claim 2 wherein said sulfur-based oxo acid moiety is sodium sulfite or sodium metabisulfite.

6. A heat stable functionalized polyolefin emulsion according to claim 1 wherein the amount of said phosphorous-based oxo acid moiety ranges from about 0.1 parts by weight to about 3 parts by weight per hundred parts by weight of functionalized polyolefin in said emulsion.

7. A heat stable functionalized polyolefin emulsion according to claim 1 wherein the amount of said phosphorous-based oxo acid moiety ranges from about 0.2 parts by weight to about 0.9 parts by weight per hundred parts by weight of functionalized polyolefin in said emulsion.

8. A heat stable functionalized polyolefin emulsion according to claim 2 wherein the amount of the sulfur-based oxo acid moiety ranges from about 0.1 parts by weight to about 3 parts by weight per hundred parts by weight of functionalized polyolefin in said emulsion.

9. A heat stable functionalized polyolefin emulsion according to claim 2 wherein the amount of said sulfur-based oxo acid moiety ranges from about 0.2 parts by weight to about 0.6 parts by weight per hundred parts by weight of functionalized polyolefin in said emulsion.

10. A heat stable functionalized polyolefin emulsion according to claim 1 wherein the yellowness index of said functionalized polyolefin is up to 50.

11. A heat stable functionalized polyolefin emulsion according to claim 10 wherein the yellowness index of said functional polyolefin is less than 40.

12. A heat stable functionalized polyolefin emulsion according to claim 10 wherein said heat stable functionalized polyolefin has a Gardner color of less than or equal to 6.

13. A heat stable functionalized polyolefin emulsion according to claim 1 wherein said functionalized polyolefin is a maleated polypropylene containing less than about 2.0% by weight grafted maleic anhydride based on the weight of the maleated polypropylene and exhibits an acid number less than about 11 mg KOH/g.

14. A heat stable functionalized polyolefin emulsion according to claim 1 wherein said functionalized polyolefin emulsion comprises at least one functionalized polyolefin, at least one non-ionic surfactant, at least one neutralizing base, at least one carboxylic acid co-surfactant, and water.

15. A heat stable functionalized polyolefin emulsion according to claim 14 wherein said functionalized polyolefin has a grafting level ranging from about 0.5% by weight to about 2.5% by weight grafted functionalizing agent based on the weight of the functionalized polyolefin; wherein said non-ionic surfactant has a HLB ranging from about 4 to about 10; and wherein said carboxylic acid co-surfactant comprises at least one linear organic carboxylic acid in an amount less than or equal to 16 parts per hundred parts of said functionalized polyolefin.

16. A heat stable functionalized polyolefin emulsion according to claim 14 wherein
said functionalized polyolefin has a grafting level ranging from about 0.5% by weight to about 2.5% by weight grafted functionalizing agent based on the weight of said functionalized polyolefin; wherein said non-ionic surfactant has a HLB ranging from about 4 to about 10; wherein said carboxylic acid co-surfactant comprises at least one linear organic carboxylic acid and at least one alicyclic organic carboxylic acid; and wherein the total amount of said carboxylic acid co-surfactant is greater than 16 parts per hundred parts of said functionalized polyolefin.

17. A heat stable functionalized polyolefin emulsion according to claim 14 wherein said carboxylic acid co-surfactant comprises at least one alicyclic organic carboxylic acid.

18. A heat stable functionalized polyolefin emulsion wherein said functionalized polyolefin has a grafting level from about 0.5% by weight to about 2.5% by weight grafted functionalizing agent based on the weight of the functionalized polyolefin; and wherein said functionalized polyolefin emulsion has a % transmittance of at least 5%.

19. A heat stable functionalized polyolefin emulsion according to any one of claims 15-18 wherein said polyolefin comprises at least one olefin monomer having from 2 to about 8 carbon atoms.

20. A heat stable functionalized polyolefin emulsion according to claim 19 wherein said polyolefin is selected from the group consisting of polyethylene, polypropylene, polybutene, and polyhexene.

21. A heat stable functionalized polyolefin emulsion according to any one of claims 15-18 wherein said functionalized polyolefin is grafted with a functionalizing agent; and wherein said functionalizing agent is any unsaturated monomer containing one or more carboxylic acid or acid anhydride groups.

22. A heat stable functionalized polyolefin emulsion according to claim 21 wherein said functionalizing agent is selected from the group consisting of carboxylic acids and acid anhydrides.

23. A heat stable functionalized polyolefin emulsion according to claim 22 wherein said functionalizing agent is selected from the group consisting of acrylic acid, methacrylic acid, maleic acid, flumaric acid, himic acid, itaconic acid, citraconic acid, mesaconic acid, methacrylic acid, crotonic acid, isocrotonic acid, maleic anhydride and himic anhydride.

24. A heat stable functionalized polyolefin emulsion according to claim 23 wherein said functionalizing agent is maleic anhydride.

25. A heat stable functionalized polyolefin emulsion according to any one of claims 15-18 wherein said functionalized polyolefin is maleated polypropylene and the grafting level of said maleated polypropylene ranges from about 1% by weight to about 2.5% by weight grafted maleated anhydride based on the weight of the maleated polypropylene.

26. A heat stable functionalized polyolefin emulsion according to any one of claims 15-18 wherein the acid number of said functionalized polyolefin ranges from about 4 to about 14.

27. A heat stable functionalized polyolefin emulsion according to any one of claims 15-18 wherein the weight average molecular weight of said functionalized polyolefin ranges from about 30,000 to about 90,000.

28. A heat stable functionalized polyolefin emulsion according to any one of claims 15-18 wherein the melt viscosity at 190° C. of said functionalized polyolefin ranges from about 20,000 centipoise to about 150,000 centipoise.

29. A heat stable functionalized polyolefin emulsion according to any one of claims 15-18 wherein the peak melt point of said functionalized polyolefin is greater than about 135° C.

30. A heat stable functionalized polyolefin emulsion according to any one of claims 15-18 wherein the amount of the functionalized polyolefin contained in the functionalized polyolefin emulsion ranges from about 10% by weight to about 35% by weight based on the weight of the functionalized polyolefin emulsion.

31. A heat stable functionalized polyolefin emulsion according to any one of claims 15-18 wherein said non-ionic surfactant has a HLB value ranging from about 6 to about 10.

32. A heat stable functionalized polyolefin emulsion according to claim 31 wherein said non-ionic surfactant has a HLB value ranging from about 7 to about 10.

33. A heat stable functionalized polyolefin emulsion according to any one of claims 15-18 wherein said non-ionic surfactant comprises at least one compound based on ethylene oxide or alkyl phenols.

34. A heat stable functionalized polyolefin emulsion according to claim 33 wherein said non-ionic surfactant is at least one selected from the group consisting of ethoxylated derivatives of C₈ to C₂₀ synthetic linear alcohols, ethoxylated C₉ to C₁₈ synthetic branched alcohols, ethoxylated alkyl phenol derivatives, mono esters of aliphatic carboxylic acids, polyethylene oxide oligomers of varying molecular weight, similar mono- or di-esters of polyhydroxy material, and mixtures thereof.

35. A heat stable functionalized polyolefin emulsion according to claim 34 wherein said non-ionic surfactant is based on the reaction of alcohols or alkyl phenols with ethylene oxide, propylene oxide, or mixtures of the two.

36. A heat stable functionalized polyolefin emulsion according to any one of claims 15-18 wherein the amount of said non-ionic surfactant present in said functionalized polyolefin emulsion ranges from about 6 parts per 100 parts of functionalized polyolefin to about 25 parts per 100 parts of functionalized polyolefin.

37. A heat stable functionalized polyolefin emulsion according to any one of claims 15-18 wherein said carboxylic acid co-surfactant is at least one selected from the group consisting of linear organic carboxylic acids and alicyclic organic carboxylic acids.

38. A heat stable functionalized polyolefin emulsion according to claim 37 wherein said linear organic carboxylic acid is at least one selected from the group consisting of linear C₁₆ to C₁₈ fatty acids.

39. A heat stable functionalized polyolefin emulsion according to claim 37 wherein said alicyclic organic carboxylic acid is at least one rosin acid.

40. A heat stable functionalized polyolefin emulsion according to claim 39 wherein said alicyclic organic carboxylic acid is at least one hydrogenated rosin acid.

41. A heat stable functionalized polyolefin emulsion according to claim 15 wherein said carboxylic acid co-surfactant is at least one linear organic carboxylic acid in an amount ranging from about 2 to about 16 parts per hundred parts of functionalized polyolefin.

42. A heat stable functionalized polyolefin emulsion according to any one of claims 15-18 wherein said carboxylic acid co-surfactant is at least one linear organic carboxylic acid and at least one alicyclic organic carboxylic acid.

43. A heat stable functionalized polyolefin emulsion according to any one of claims 15 or 18 wherein the total amount of carboxylic acid co-surfactant in said functionalized polyolefin emulsion is greater than 8 parts per hundred parts of functionalized polyolefin.

44. A heat stable functionalized polyolefin emulsion according to claim 43 wherein the total amount of carboxylic acid co-surfactant in said functionalized polyolefin emulsion ranges from about 8 parts to about 25 parts per hundred parts of functionalized polyolefin.

45. A heat stable functionalized polyolefin emulsion according to claim 42 wherein the amount of said alicyclic organic carboxylic acid ranges from about 1% by weight to about 99% by weight of the total amount of carboxylic acid co-surfactant.

46. A heat stable functionalized polyolefin emulsion according to claim 45 wherein the amount of said alicyclic organic carboxylic acid ranges from about 25% by weight to about 75% by weight of the total amount of carboxylic acid co-surfactant.

47. A heat stable functionalized polyolefin emulsion according to claim 16 wherein the maximum amount of said carboxylic acid co-surfactant is 16 parts per 100 parts of functionalized polyolefin and the remainer of the carboxylic acid co-surfactant is an alicyclic carboxylic acid.

48. A heat stable functionalized polyolefin emulsion according to claim 17 wherein the amount of said alicyclic organic carboxylic acid ranges from about 5 parts to 25 parts per hundred parts of functionalized polyolefin.

49. A heat stable functionalized polyolefin emulsion according to claim 1 wherein said heat stable functionalized polyolefin further comprises at least one selected from the group consisting of antioxidants, optical brighteners, and colorants.

50. A heat stable functionalized polyolefin emulsion according to claim 49 wherein said antioxidant is a phosphite or thiodipropioniate ester.

51. A composition comprising a heat stable functionalized polyolefin emulsion wherein said functionalized polyolefin emulsion when heat aged has a Gardner Color of less than or equal to 6.

52. A process to produce a heat stable functionalized polyolefin emulsion comprising adding at least one additive to said functionalized polyolefin emulsion wherein said additive comprises at least one phosphorous-based oxo acid moiety.

53. A process according to claim 52 wherein said additive comprises at least one phosphorous-based oxo acid moiety and at least one sulfur-based oxo acid moiety.

54. A process to produce a heat stable functionalized polyolefin emulsion comprising contacting at least one functionalized polyolefin, at least one non-ionic surfactant, at least one carboxylic acid co-surfactant, at least one neutralizing base, water, and at least one additive; wherein said additive comprises at least one phosphorous-based oxo acid moiety.

55. An article comprising the heat stable functionalized polyolefin emulsion of claim 1.
